(19) United States
(12) Patent Application Publication
(10) Pub. No.: US 2002/0086197 A1
(43) Pub. Date: Jul. 4, 2002

(54) Fuel cell

(76) Inventors: Norbert Breuer, Ditzingen (DE); Christian Schiller, Echterdingen (DE)

Correspondence Address: Walter Ottesen, Patent Attorney, P.O. Box 4026, Gaithersburg, MD, 20885-4026, US

(21) Appl. No.: 10/025,614

(22) Filed: Dec. 26, 2001

(30) Foreign Application Priority Data
Dec. 23, 2000 (DE) 100 65 009.0

(51) Int. Cl. H01M 8/04; H01M 8/06; H01M 4/96

(52) U.S. Cl. 429/34; 429/19; 429/44; 429/38

(57) ABSTRACT

The invention is directed to a fuel cell wherein the short-term reduction of the fuel cell power during increased power requirements on the system is reduced or entirely prevented as may be possible. For this purpose, an internal fuel store is provided within the cell housing.

### BACKGROUND OF THE INVENTION

A fuel cell is an electrochemical cell which can continuously convert the chemical energy of a fuel into electrical energy. The chemical compounds, which are required for the reactions, are supplied to the fuel cell from the outside mostly in a gaseous state. A classification of different fuel cell types is generally made based on the different operating temperatures. Known systems in the low-temperature range are characterized as polymer-electrolyte membrane fuel cells.

The principal configuration of these cells includes two electrodes, an electrolyte and a cell housing. One of these electrodes functions as a cathode on which a substance is electrochemically reduced while the other electrode is correspondingly an anode. Here, a second compound is electrochemically oxidized. The electrolyte is disposed between the electrodes and is an electronic insulator in order to avoid a short circuit and is simultaneously, however, accessible to ion conduction. In addition to sealing off the fuel cell, the cell housing functions also for leading off the useable electric current and a distributor structure for the reaction gases.

The supply of the gases into the fuel cell takes place such that it corresponds to the particular power requirements imposed on the fuel cell because a consumption of energy is connected with the transport of the gases which considerably influences the efficiency of the fuel cell system. This energy consumption is, for example, for compressors, compactors, thermostating, et cetera. This is significant especially for hydrogen which is either produced via a reforming unit or is made available from a storage system.

In the event that power peaks occur during the operation of a fuel cell (that is, the conversion of the gases in the cell must be increased in a very short time), a depletion of the gases in the gas distribution structure can occur so that the fuel cell cannot supply the required power.

As a side effect, higher current densities occur at the gas inlet of the fuel cell than at the gas outlet and this is associated with a variably high development of heat and can lead locally also to a thermal failure of the membrane. This is known as so-called “burn holes”.

In existing fuel cells, it is attempted to counter this effect in that an excess of oxygen or air (that is, more than is required in accordance with a stoichiometric conversion with hydrogen) is conducted through the fuel cell at the cathode end. For the anode end, this cannot be carried out in the same manner since, because of limited stores of fuel, the operating duration is reduced and the operating costs would increase which are determined essentially by making available the fuel.

Furthermore, fuel cell systems are known which are equipped with a second energy converter (for example, in the form of batteries or condensers) and operate to a certain extent as buffers when there are power peaks. What is disadvantageous here is the greater complexity of the heating system, the increased requirement as to volume, an increased control complexity and higher system costs.

### SUMMARY OF THE INVENTION

In contrast to the foregoing, it is an object of the invention to provide a fuel cell wherein the short-term drop of the fuel cell power is reduced during increased power demand on the system or the short-term drop is avoided entirely.

The fuel cell of the invention includes: a cell housing; first and second electrodes mounted in the cell housing; an electrolyte disposed in the cell housing; and, an internal fuel store disposed within the cell housing.

According to a feature of the fuel cell of the invention, an internal fuel store is provided within the cell housing. With the aid of such an internal fuel store, an adequate quantity of fuel is available for the electrochemical conversion at the anode in the case of increased power demand with almost no time delay so that a drop in power of the fuel cell can be reliably avoided. The internal fuel cell store functions as a buffer until the fuel supply can be correspondingly controlled upwardly. The fuel cell store can be filled during the normal fuel cell operation via the fuel feed.

Advantageously, the internal fuel store according to the invention is provided in fuel cells which have gas distribution structures at the electrodes for distributing a gaseous fuel. In a specific embodiment of the invention, the fuel store of the invention is integrated into this gas distribution structure.

In this way, the integration of a fuel cell store according to the invention is possible without the volume of the fuel cell being increased or the total configuration being affected in any other way.

All storage techniques known and future storage techniques can be applied to realize the fuel cell store.

For example, it is conceivable in a special embodiment of the invention to use a so-called hydride store, that is, a storage metal. Such storage metals have already become known especially for storing hydrogen. For example, appropriate metal alloys are described in U.S. Pat. No. 5,840,440. In addition to the alloys having different compositions and different structures with nickel, cobalt, lanthanum, et cetera, also pure metals, such a palladium, can be used as storage metals.

When using storage metals, an especially advantageous embodiment of the invention is provided in that the storage metal is applied to at least a portion of the gas distribution structure as a surface coating. With this measure, a fuel store can be integrated into proven gas distribution structures without a change of its structural shape and especially without geometric changes.

Here, the material can be either on the entire gas distribution structure or in the so-called channel structures.

The coating can take place in dependence upon the selected bonding in the most varied way. In metals, coating methods from the gas phase, that is, by sputtering or so-called CVD methods, can be used. Metallization by means of galvanic methods can also be used.

In addition, for pure metals as well as for alloys, the substances can be produced in a powder form which is bonded by sintering with the carrier material. When only coating the channel structure, all materials known at the present time for fuel stores can be pressed into the channels of the gas distribution structure.

The thickness of the coatings can be comparatively slight because the energy density in the form of hydrogen within the materials can lie higher than in the pure gas phase by a factor of up to 10,000. Therefore, layers of <500 nm, for example, of 100 nm are adequate for the storage layer for a channel height of <500 μm, for example, of 200 μm. For a channel height of 200 μm, a 100 μm thick storage layer has, for example, a higher hydrogen supply by a multiple than a gas phase located in the gas distribution structure.

In addition to the use of store coatings, the structuring of the fuel store can also be considered. Accordingly, so-called carbon nanostructures such as so-called nanotubes, nanoshells, nanofibers, et cetera are described in U.S. Pat. No. 5,653,951. Basically, such carbon structures as well as other known or future storage configurations can be applied as internal fuel stores in accordance with the invention.

In addition to the integration of the internal fuel store into the gas distribution structure, an integration into the gas permeable electrode structure of the fuel cell can be considered. In this configuration, the stored fuel is already directly where it is needed in the event of the above-described increased demand.

A combination of the above-mentioned embodiments, that is, the configuration of an internal fuel store in the gas distribution structure as well as in the electrode structure can also be used as required whereby, in total, the storage capacity is increased. In addition, further internal fuel stores can be provided.

What is essential in the invention is the situation that an adequate fuel quantity can be stored via the internal fuel store in the fuel cell itself, that is, directly at the location of the electrochemical conversion. With this store, a possible insufficiency of fuel because of a short-term increase in power requirement can be avoided.

It is especially advantageous that, in the case of power peaks, temperature increases can occur in the cell which accelerate the release of stored hydrogen. Because this resorption process is endothermal, an advantageous smoothing of the time-dependent temperature profile occurs at the same time.

### BRIEF DESCRIPTION OF THE DRAWINGS

The invention will now be described with reference to the drawings wherein:

FIG. 1 is a schematic showing the basic configuration of a fuel cell according to the invention;

FIG. 2 is a schematic of a gas distribution structure of the fuel cell of FIG. 1;

FIG. 3 is a schematic cross section taken through the gas distribution structure of FIG. 1 along line III-III; and,

FIG. 4 is a schematic corresponding to FIG. 3 showing an additional embodiment of the gas distribution structure.

### DESCRIPTION OF THE PREFERRED EMBODIMENTS OF THE INVENTION

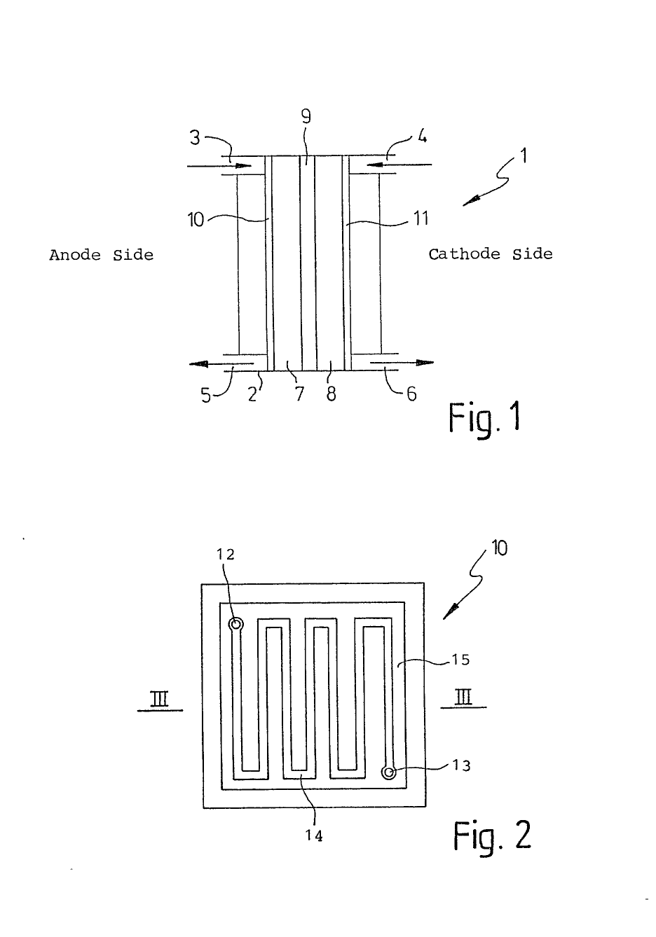

FIG. 1 shows a fuel cell 1 having a cell housing 2 at whose upper side a fuel inlet 3 as well as an air inlet 4 are provided. At the lower side, two gas outlets (5, 6) are provided via which the exhaust gas products, that is, the end products, which result from the electrochemical reaction of the fuel with oxygen, are directed away.

In the interior of the cell housing 2, two electrodes (7, 8) are arranged, separated from each other by an electrolyte 9. The electrode on the side of the fuel inlet 3 defines the anode 7 and the electrode at the air inlet 4 defines the cathode. The anode 7 and the cathode 8 are provided with a catalytic material in the usual manner in order to accelerate the electrochemical conversion of the fuel.

To improve the power density of the fuel cell, gas distribution structures (10, 11) are utilized which increase the active surfaces of the electrodes (7, 8). An example for such a gas distribution structure is shown in FIG. 2. A channel structure 14 having a meander form is provided between a gas inlet 12 and a gas outlet 13. The substrate 15 with this channel structure 14 is formed as a flat plate on which the channel structure is formed on one side thereof. The gas distribution structures (10, 11) are joined at their structured sides to the electrodes (7, 8) as shown in FIG. 1.

According to the invention, the walls of the channel structure 14 can be provided with a hydrogen store, for example, by coating with a hydrogen-storing material as described above. In this way, it is possible to store such a quantity of fuel, for example, hydrogen, in the gas distribution structure 10 of the anode 7 which is sufficient to cover the requirements during power peaks. The initially-mentioned insufficiency of fuel with the corresponding drops in power is thereby reliably avoided.

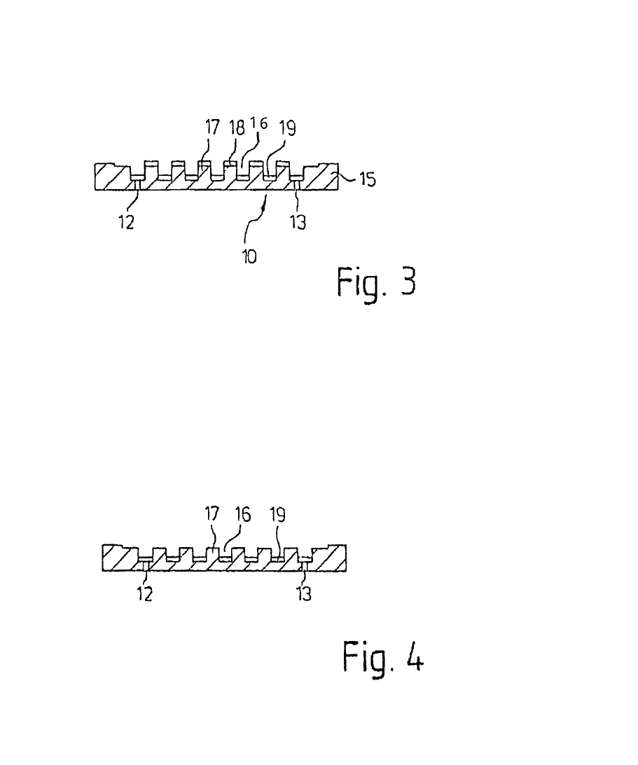

In FIG. 3, a schematic cross section through the gas distribution structure 10 is shown which is taken, for example, along the section line III-III of FIG. 2.

The channels 16 are clearly recognizable as rills in the substrate 15. The rills are separated from each other by walls 17. The gas inlet 12 as well as the gas outlet 13 are indicated in FIGS. 3 and 4 even though the inlet and outlet lie forward of and rearward of the drawing planes of FIGS. 3 and 4 for the embodiment shown in FIG. 2. However, in this way, it can be seen how the gas inlet and gas outlet can be realized in the gas structure 14.

In the embodiment of FIG. 3, the channels 16 as well as the walls 17 are provided with a coating (19, 18) which comprises a storage metal. These coatings (18, 19) thereby form the internal hydrogen store in accordance with the invention.

In the embodiment of FIG. 4, only the channels 16 are provided with a coating 19 and the walls 17 are left in their original condition. Although the embodiment of FIG. 3 provides a larger internal hydrogen store, the embodiment of FIG. 4 affords the advantage that the contact location between the electrode and the gas distribution structure (10, 11) is not modified and therefore the connection or bonding between the electrodes (7, 8) and the gas distribution structures (10, 11), respectively, can be produced in a proven manner.

In lieu of the coatings (18, 19), carbon structures can also be used as mentioned above or other known or future forms of hydrogen stores can be applied.

It is understood that the foregoing description is that of the preferred embodiments of the invention and that various changes and modifications may be made thereto without departing from the spirit and scope of the invention as defined in the appended claims.

What is claimed is:

1. A fuel cell comprising:
a cell housing;
first and second electrodes mounted in said cell housing;
an electrolyte disposed in said cell housing; and,
an internal fuel store disposed within said cell housing.

2. The fuel cell of claim 1, said first electrode being an anode and encompassing said fuel store.

3. The fuel cell of claim 2, wherein said fuel store is provided in a gas distribution structure in said anode.

4. The fuel cell of claim 3, wherein said fuel store includes a storage metal.

5. The fuel cell of claim 4, wherein said storage metal is an alloy of storage metals.

6. The fuel cell of claim 4, wherein said storage metal is applied to at least a part of said gas distribution structure of said anode as a coating.

7. The fuel cell of claim 6, wherein said coating of said storage metal is formed to have a thickness of less than 500 nm for an average channel height in said distribution structure of less than 500 μm.

8. The fuel cell of claim 6, wherein said coating of said storage metal has a thickness of approximately 100 nm for an average channel height in said gas distribution structure of 200 μm.

9. The fuel cell of claim 2, wherein said electrodes are porous electrodes; and, said internal fuel store encompasses a coating of the porous electrodes.

10. The fuel cell of claim 2, wherein said fuel store encompasses carbon nano-structures.

11. The fuel cell of claim 10, wherein said carbon nano-structures are provided in the gas distribution structure of said anode.
